(19) United States
(12) Patent Application Publication
(10) Pub. No.: US 2012/0303415 A1
(43) Pub. Date: Nov. 29, 2012

(54) SYSTEM AND METHOD OF PROVIDING RECOMMENDATIONS

(76) Inventor: Ari Edelson, New York, NY (US)

(21) Appl. No.: 13/449,931

(22) Filed: Apr. 18, 2012

Related U.S. Application Data
(60) Provisional application No. 61/489,731, filed on May 25, 2011.

(51) Int. Cl. G06Q 30/02

(52) U.S. Cl. 705/7.32

(57) ABSTRACT

Systems and methods for providing recommendations directed to cultural events, such as films, theatre shows, concerts, etc., via an online site are described. The systems and methods may also be used to provide recommendations for restaurants, books, television shows or other subjects. The system and method include a trainable recommendation engine that collects, aggregates, and combines trusted recommendations to create a personalized list of recommended events. Algorithms are used to gather and aggregate individual reviews of events and event listings, restaurants, books or other subjects from the Internet, aggregate the likes and dislikes of individuals who provide reviews to generate customized recommendations for the user, and constantly improve each user's experience by identifying likeminded individuals within the system.

### PRIORITY

The present application claims priority under 35 U.S.C. §119(e) to U.S. Provisional Patent Application No. 61/489,731 filed on May 25, 2011, the entire contents of which are hereby incorporated by reference.

### FIELD OF THE INVENTION

The present invention relates generally to providing recommendations directed to cultural events, restaurants, books or other subjects via an online site.

### BACKGROUND OF THE INVENTION

Recommendation services are available via online sites. These recommendation services are often limited in scope. Additionally, existing recommendation services are typically based on the aggregated opinions of all users or the opinions of editors who are likely not familiar with the individual preference of a visitor to the online site. Hence, there is a need for an improved system and method of providing recommendations.

### SUMMARY OF THE INVENTION

The present invention relates to systems and methods for providing recommendations directed to cultural events, such as films, theatre shows, concerts, etc., via an online site. The present invention may also be used to provide recommendations for restaurants, books, television shows or other subjects. It should be understood that the term “cultural event” as used herein may apply to any of these topics or any other topic for which a person may wish to consider the recommendations or opinions of others.

In one embodiment, the system and method include a trainable recommendation engine that collects, aggregates, and combines trusted recommendations to create a personalized list of recommended events. In particular, the present invention is based on algorithms that gather and aggregate individual reviews of events and event listings, restaurants, books or other subjects from the Internet, aggregate the likes and dislikes of individuals who provide reviews to generate customized recommendations for the user, and constantly improve each user's experience by identifying likeminded individuals within the system. When a user selects an individual reviewer with matching affinities, the recommendations become increasingly diverse and accurate.

In one embodiment, the present invention relates to a method for providing recommendations to a user comprising the steps of: receiving a rating of one or more cultural events by a user; receiving a rating of one or more cultural events by one or more individual reviewers; comparing the rating of the cultural event by the user against the rating of the cultural event by the individual reviewers to determine the degree of affinity for cultural events between the user and the one or more individual reviewers; analyzing reviews of cultural events by the one or more individual reviewers to determine whether they liked or disliked a particular cultural event; calculating a score rating the likelihood that the user will like or dislike the cultural event using an algorithm based upon the degree of affinity between the user and the individual reviewers; and generating a list of cultural events that the user is likely to like or dislike based upon the reviews by individual reviewers that have a high affinity with the user.

In another embodiment, the present invention provides a computer-readable storage medium having computer-readable instructions for instructing at least one computer system to generate a list of recommended cultural events. The instructions cause the computer system to execute the steps of: gathering and aggregating individual reviews of events and event listings from the Internet; aggregating the likes and dislikes of individual reviewers who a user trusts to generate customized recommendations; constantly improving each user's experience by identifying likeminded individual reviewers within the system; transmitting a list of recommended cultural events to the local computer system; and displaying the list to the user on the local computer system.

The present invention also provides a system comprising a computer-readable medium alone and/or in combination with additional apparatus. For example, the server can comprise computer readable medium, which can have program code.

### BRIEF DESCRIPTION OF THE DRAWINGS

For a more complete understanding of the present invention, reference is made to the following Detailed Description of the Invention, considered in conjunction with the accompanying drawings.

FIG. 1 is a diagram showing the system of the present invention.

FIG. 2 is a diagram showing various applications that could interact with the system.

FIG. 3 is a diagram showing hardware components of the server of the present invention, in greater detail.

FIG. 4 is a flowchart showing processing steps carried out by the present invention for allowing a user to create an account with an online website when accessing the online website for the first time.

FIG. 5 is a flowchart showing processing steps carried out by the present invention for importing information relating to a review of an event into the server.

FIG. 6 is a flowchart showing processing steps carried out by the present invention to provide an affinity score for a user and an individual.

FIG. 7 is a flowchart showing processing steps carried out by the present invention to create a user's personalized list of recommended cultural events from individuals selected by the user.

FIG. 8A is a screenshot of a user interface in the form of a sign-up page from the online site generated by an embodiment of the present invention.

FIG. 8B is a screenshot of a user interface in the form of a sign-up page from the online site generated by another embodiment of the present invention.

FIGS. 9A-9C are screenshots of three sample homepages from the online site generated by the present invention.

FIG. 10 is a screenshot of a profile page from the online website generated by the present invention.

FIG. 11 is a screenshot showing an event page from the online site generated by the present invention.

FIG. 12 is a screenshot showing a review page from the online site generated by the present invention.

FIG. 13 is a diagram of a user's experience on the online website.

### DETAILED DESCRIPTION OF THE INVENTION

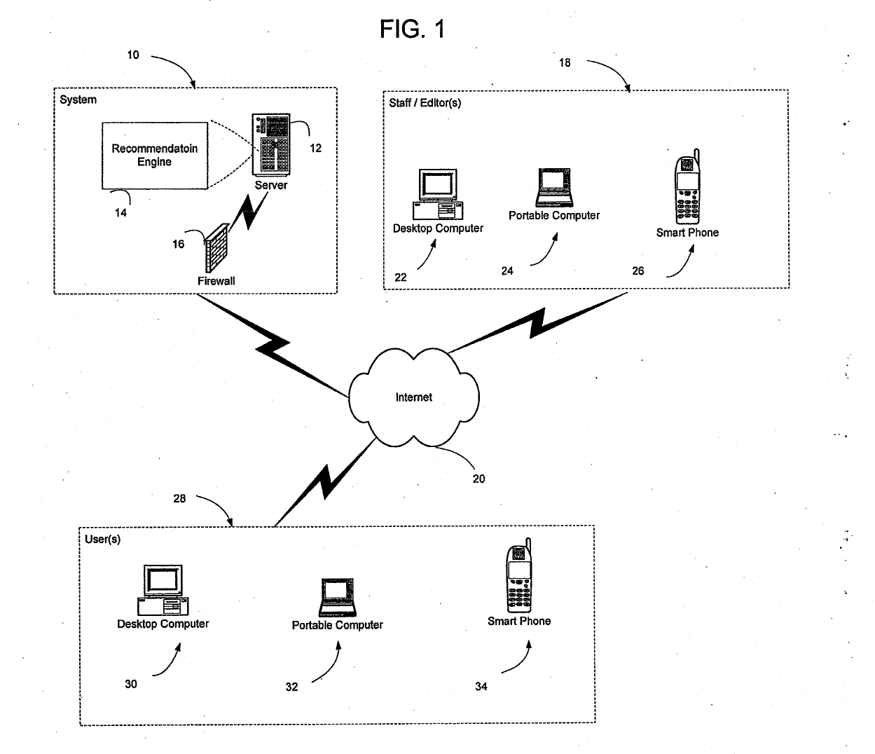

The present invention relates to a system and method for providing recommendations directed to cultural events, as discussed in detail below and in connection with FIGS. 1-13. The embodiments taught herein are described in connection with cultural events, such as plays, theater, dance performances, art exhibits, films, movies, and live and visual arts and events, etc. It should be understood, however, that the teachings herein can be used with other types of events, books, restaurants, real estate, education, and fashion, etc. The term “cultural event” as used herein may apply to any of these topics or any other topic for which a person may wish to consider the recommendations or opinions of others.

FIG. 1 is a diagram showing an embodiment of a system to provide recommendations, indicated generally at 10. The system 10 includes a server 12, a recommendation engine 14 stored on and executed by the server 12, and a firewall 16 to prevent unauthorized access. As will be discussed in greater detail below, the system 10 provides a web-based system that calculates a score rating the likelihood that a user will like or dislike a particular event or other rated item based upon the affinity between a user and individual reviewers. The individual reviewers may be professional critics, friends, family members, or other users on the system that are identified by the system or the user. The score is based upon ratings of cultural events or other items by the individual reviewers and allows a user to select which cultural events to attend, based on the likes and dislikes of the individual reviewers identified by the user or identified by the system as having a high affinity with the user. As will be described below, the user can select individual reviewers that he/she trusts, or the system will identify those individual reviewers with whom the user has a high likelihood of having similar tastes or likes. The system 10 can prompt the user to select individuals who have similar affinities for cultural events. The server 12 can be any desired computer server hardware having any desired hardware architecture. Further, the server 12 can run any appropriate operating system, such as Windows, etc. The server 12 is adapted to provide an online website that includes a display of recommended cultural events and various other information, as will be described below. The server 12 is in communication with one or more staff/editors 18 of the online website. Each of the staff/editors 18 may have a computer system in communication with the server 12 over a network 20, such as an Internet Protocol (IP) network, which could include the Internet, an intranet, an extranet, a wide area network (WAN), a local area network (LAN), or a wireless network. The computer system can be, for example, a desktop computer 22, a portable computer 24, or a web-enabled mobile communication device, such as a smart phone 26. The portable computer 24 can be, for example, a laptop computer, a notebook computer, a tablet personal computer, a handheld computer, or a personal digital assistant (PDA).

The system 10 is accessible by one or more visitors to the online site, such as a user 28, via the network 20 on any desired computer system, such as a desktop computer 30, a portable computer 32, or a smart phone 34. The system 10 generates a user interface on the online site for the user 28.

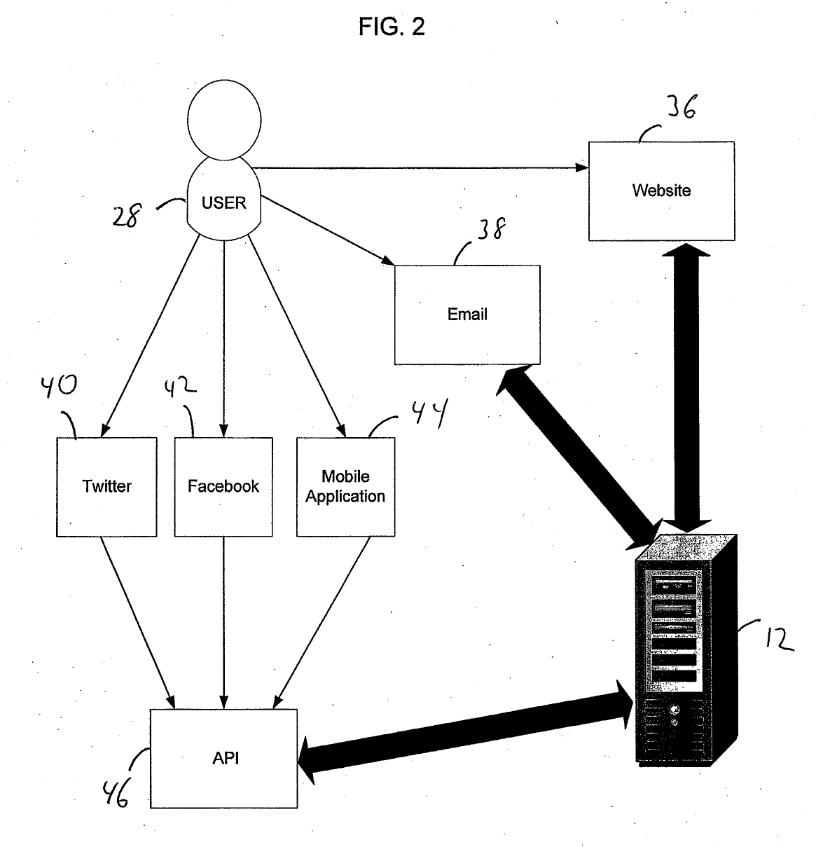

FIG. 2 is a diagram showing various applications that can interact with the server 12. In particular, the user 28 can interact with the server 12 using the online website 36, email 38, social media sites such as Twitter 40 or Facebook 42, or a mobile application 44 via an Application Programming Interface (API) 46, etc.

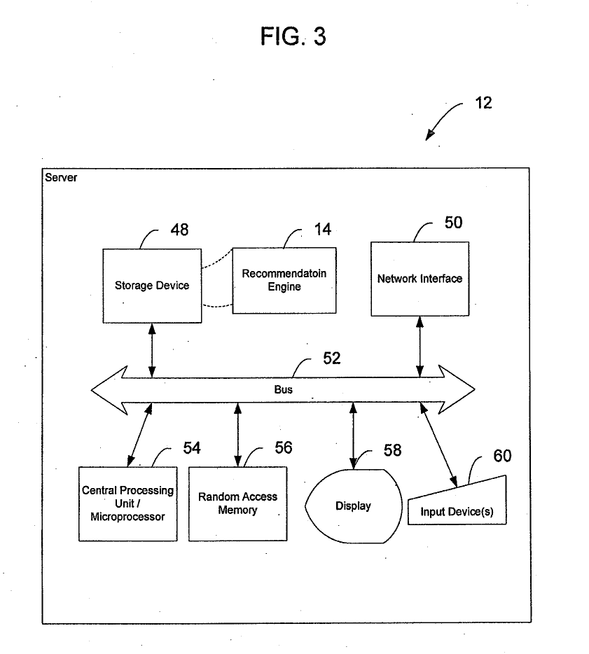

FIG. 3 is a diagram showing various hardware and software components of one embodiment of the server 12 in greater detail. In one embodiment, the server 12 includes a storage device 48, a network interface device 50, a communications bus 52, a central processing unit (CPU) 54, a random access memory (RAM) 56, a display 58, and one or more input devices 60, such as a keyboard, mouse, etc. The storage device 48 can comprise any suitable computer-readable storage medium such as disk, non-volatile memory, etc. The recommendation/matching engine 14 of the present invention can comprise computer-readable program code stored on the storage device 48 and executed by the CPU 54, and can be coded using any suitable, high- or low-level computing language, etc. The network interface 50 can include a network interface device, a wireless network interface device, or any other suitable device which permits the server 12 to communicate via the network 40 of FIG. 1. The CPU 54 can include any suitable single- or multiple-core microprocessor.

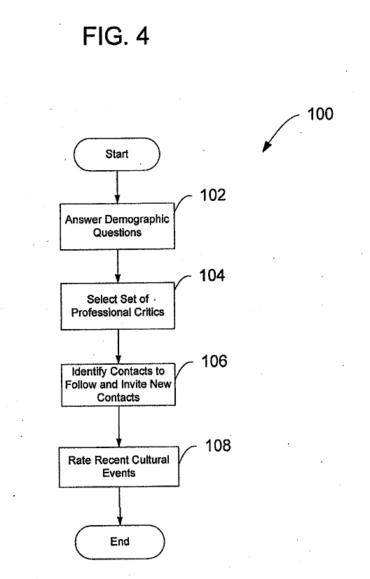

FIG. 4 is a flowchart showing processing steps for one embodiment of the invention, indicated generally at 100, for allowing the user 28 to create an account with the online website 36 when accessing the online website 36 for the first time. Beginning in step 102, the user 28 is prompted to answer demographic questions, such as gender, age range, postal code, etc. In step 104, the user 28 may select an initial set of professional critics. Alternatively, the user may elect to have the system assign a preselected list of professional critics for initial comparison and recommendations.

In step 106, the user 28 may identify e-mail, Facebook, and/or LinkedIn contacts, or other contacts that may be registered in the system, to follow on the online site 36, and invite contacts not yet registered with the online site 36 to enroll. Of course, the online site 36 could prompt the user 28 to identify contacts on other social networking sites.

Steps 104 and 106 generate a list of individuals, such as friends and family members of the user 28, and/or professional critics, who the user 28 trusts and would like to follow. This list is used to create a network for the user 28, which is stored in the database of the server 12. In step 108, the user 28 rates recent cultural events, which information is processed by the server 12 to refine a personalized list of cultural events that the user 28 may be interested in attending. This information can be used to match users with individuals who have similar affinities for cultural events, as will be described below. It will be understood that it is not necessary to include all of the steps described above for the user to have access to the site, and that less or more information may be provided as desired by the user. Generally, more information is likely to result in a better match of like and dislikes between a user and individual reviewers.

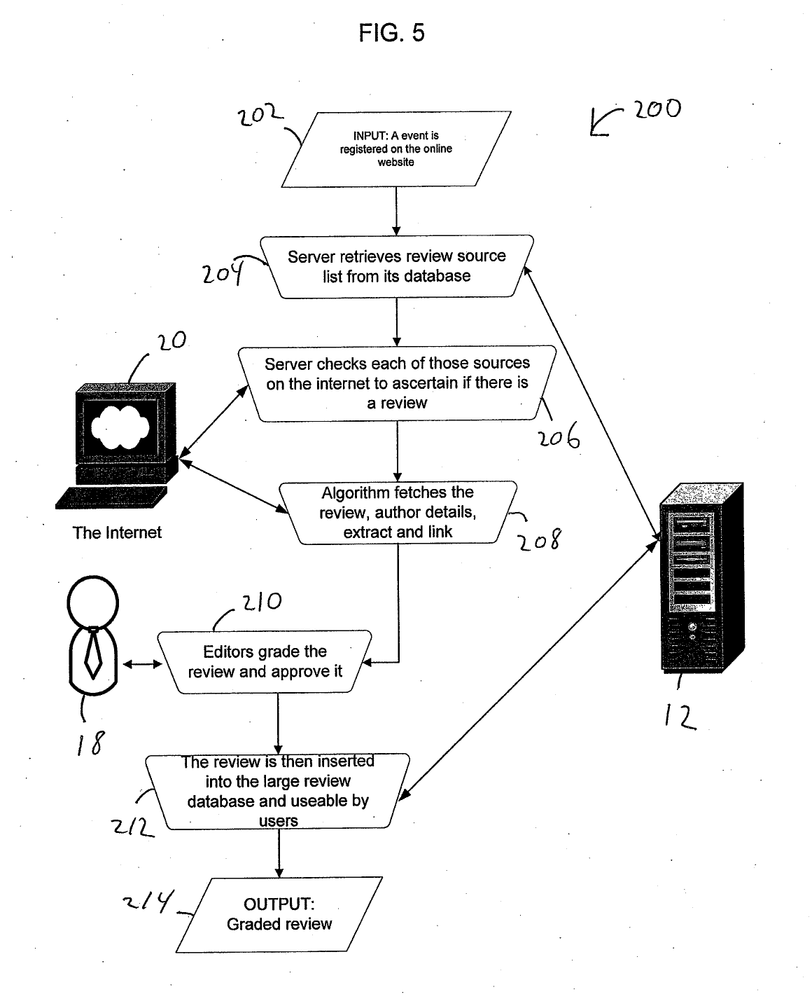

FIG. 5 is a flowchart showing processing steps for one embodiment of the invention, indicated generally at 200, for importing information relating to a review of an event into the server 12. Beginning in step 202, an event is registered on the online website 36. In step 204, the system 10 reviews a list of sources in a database stored in server 12 that includes, for example, websites or other sources that may publish reviews of cultural events. In step 206, the server 12 accesses each of the sources on the Internet to ascertain whether there is a review of the registered event. In step 208, if there is a review of the registered event published in the source, the server 12 extracts a link to the review and gathers information about the author of the review. In step 210, the editor/staff 18 of the online website 36 grades the review and if appropriate, approves the review. In one embodiment, the review is graded on a scale of 1 to 10, with 10 indicating a strong like of the registered event and 1 indicating a strong dislike of the registered event. In addition, a more general score of +1 may be assigned if the individual reviewer liked the cultural event, or a score of −1 if the reviewer disliked the event. These general scores may be used when determining an affinity score as discussed in more detail below. Then, in step 212, the review is inserted into a database in the server 12 which is used as described more fully below to provide a score to the user that indicates the likelihood that the user will like the registered event. The database may also be made available to the users if desired to allow users to review the grades assigned to individual reviews. In step 214, the server 12 generates a graded review of the event.

The present invention utilizes a series of alogorithms to generate a numerical score that represents the likelihood that a user will like or dislike a registered event. In one embodiment, an affinity score is first generated. The affinity score is a measure of the degree to which a user and an individual reviewer (e.g., other visitors of the online site, professional critics, friends, etc.) agree on whether they like or dislike particular cultural events. An initial affinity score is generated by having a user input his or her own rating (e.g. like or dislike) for one or more cultural events. As more initial cultural events are rated by the user, the affinity score will better reflect the affinity with individual reviewers. The user's initial inputs are compared against an individual reviewer's rating of the event to determine the degree of affinity between the user and the individual reviewer. A user and an individual are matched based on the degree of affinity between them. In general, the higher the affinity score, the more likely it will be that the recommended cultural event is of interest to the user.

In one embodiment, the affinity score is determined by determining the number of times a user agrees with an individual reviewer in liking or disliking a particular cultural event. The individual reviewers are then ranked from most number of agreements to least number of agreements and a percentile value is assigned to the individual reviewer based upon their position in the ranking. The percentile ranking is the affinity score. For example, if an individual reviewer is in the 90th percentile for agreements with a user in liking or disliking cultural events, that individual reviewer will be assigned an affinity score of 90. In one embodiment, the individual reviewers are grouped in deciles and all individual reviewers in a decile are assigned the same affinity score. In another embodiment, each individual reviewer is assigned an affinity score based upon the actual percentile number.

It will be understood that an affinity score may be calculated in other ways and still be within the scope of the invention. For example, average numbers of agreements on cultural events can be used, raw numbers of agreements can be used, or other methods may be used. In each case, other aspects of the method discussed below may also be adjusted to accommodate different techniques for measuring affinity scores.

After attending a cultural event, the user may enter the system and indicate whether they liked or disliked the event. The affinity score may be recalculated following each new entry by a user. Alternatively, the affinity score may be recalculated periodically, or after a predetermined number of new entries.

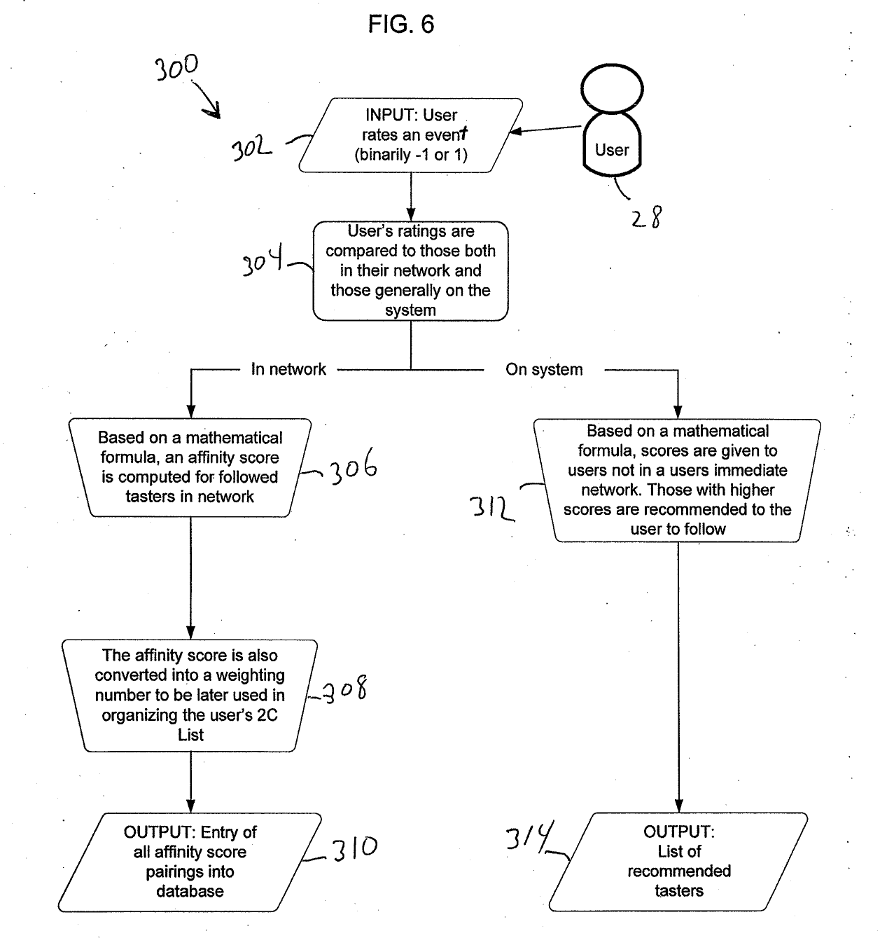

FIG. 6 is a flowchart showing processing steps for an embodiment of the invention, indicated generally at 300, to provide an affinity score between a user 28 and individual reviewers. Beginning in step 302, the user 28 is prompted to rate an event. The rating can be binary (if the user 28 liked the event, a value of “1” would be received or if the event was not liked by the user 28, a value of “−1” would be received). Alternatively, the user may score the event on a scale from 1 to 10 with 10 indicating a strong like of the registered event and 1 indicating a strong dislike of the event, and this score can be compared to the scores assigned to reviews of the events by the editor/staff as discussed above to further refine the affinity score.

In step 304, the user's ratings are compared to the ratings of the individual reviewers in the user's network and to the individual reviewers listed generally in the database of the server 12. For new users, the system may initially assign individual reviewers that will be compared to the user. A determination is made as to whether the individual is in the user's network or whether the individual is listed generally in the database of the server 12. If the individual is in the user's network, steps 306-310 occur. In step 306, an affinity score is computed between the user and the individual reviewer as discussed above.

Next, in step 308, the affinity score is converted by the server 36 into a weighting number to be later used in generating the user's event recommendations, which is quantified in a personalized list of recommended cultural events. In one embodiment, the weighting number is determined by dividing the affinity score by 100 and adding 0.5 to the result. For example, if the affinity score for an individual reviewer is 90, the weighting number would be 1.4. If the affinity score were 10, the weighting number would be 0.6. The weighting number is used as further described below to generate the user's “2C List,” which is a listing of recommended events generated by the system for the user. In one embodiment, ten cultural events could be identified in the 2C List. It should be understood that the 2C List could include any number of cultural events. The affinity scores and weighting numbers are stored in a database on the server 32.

It will be recognized that the weighting number can be determined in a variety of ways depending upon the relative weights that one may wish to assign to those with higher or lower affinity scores. For example, a higher number might be added to individual reviewers with an affinity score above 50 and a lower number added to those below 50. This can be modified in numerous ways within the scope of the invention.

The system can also be used to identify other users with similar tastes. Other users can be scored using an affinity score alone, or other scoring method, to determine whether the other user has tastes similar to user 28. In step 312, affinity scores are determined for other system users not already in the user's network. Other users who have an affinity score above a predetermined threshold, such as 80 for example, are recommended to the user 28 to follow. In step 314, a list of such other users (referred to as “tasters”) is generated.

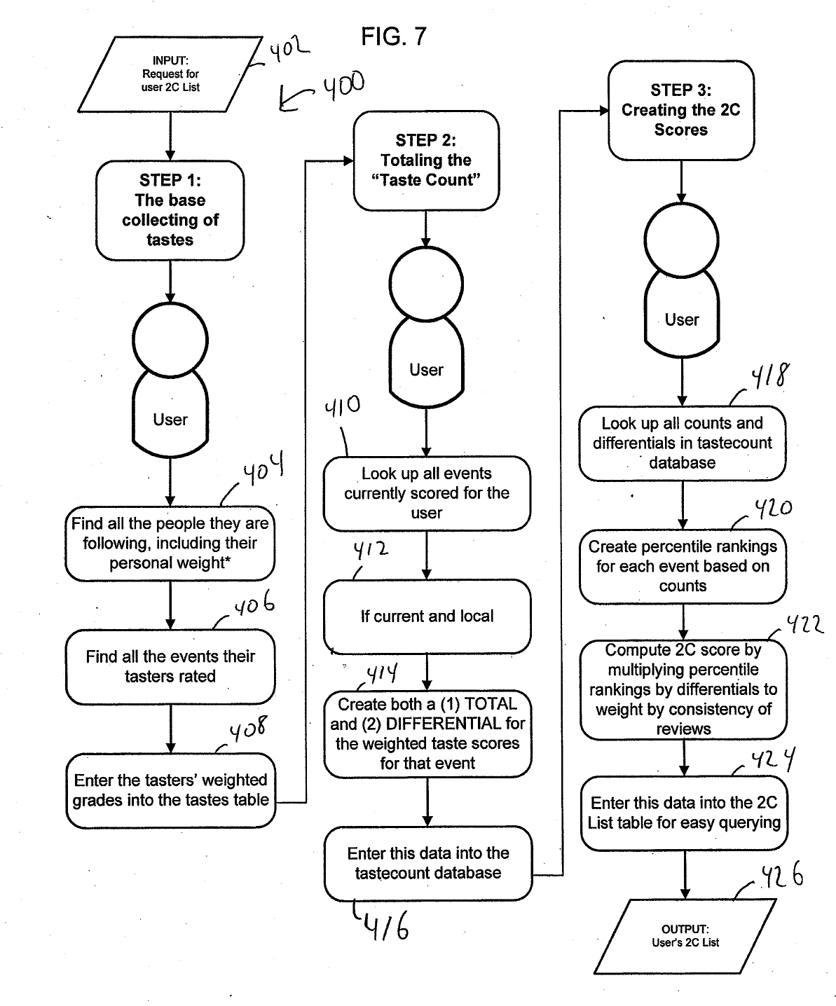

FIG. 7 is a flowchart showing processing steps, indicated generally at 400, to create a user's personalized list (the “2C List”) of recommended cultural events from individual reviewers in the user's network. In step 402, the server 12 receives a request for the user's 2C List. In step 404, the server 12 retrieves all of the individual reviewers in the user's network and the individual reviewer's weighting number as determined in step 308 of FIG. 6 discussed above. In step 406, the server 12 retrieves all of the events rated by the individual reviewers (referred to as “tasters” in FIG. 7) in the user's network.

In step 408, the weighted grades for each event and for each individual reviewer is entered into a table. The weighted grades may be calculated by multiplying the grade assigned to reviews by the editor/staff as discussed above by the weighting number for the individual reviewer determined as discussed above. In another embodiment, the event is assigned a +1 if liked by the reviewer or a −1 if not liked by the reviewer, and this binary number is multiplied by the weighting number.

In step 410, the server 12 retrieves all events currently scored for the user 28. In step 412, a determination is made as to whether the events are currently and locally available to the user. If the event is available, in step 414, a total score and a differential score are calculated for the event. The total score is the total of the weighted number of likes and the weighted number of dislikes for all of the individual reviewers. For example, if the total number of weighted likes is 2, and the total number of weighted dislikes is −10 (dislikes are assigned negative numbers), then the total score for the event will be −8. The differential score is determined by dividing the total score by the total number of weighted likes and dislikes. In the example described above where the total score is −8, the differential score is −8/12, or −0.67. In this example, the negative rating indicates that the individual reviewers that are followed by the user did not like the event. By contrast, if the weighted likes were 9 and the weighted dislikes were −6, the total score would be +3 and the differential score would be +0.2 (+3/15). The differential score will fall between −1 (universally disliked) and +1 (universally liked). The total score and differential score for the event is entered in a database of the server 12 in step 416.

A list of recommended events for the user to see, referred to as the “2C List,” is generated from the total score and the differential score. In one embodiment shown in FIG. 7, a 2C List is generated by first retrieving all total scores and differential scores in the database of the server 12 as shown in step 418. Then, in step 420, a percentile ranking is created for each event based on the total score assigned to that event. In step 422, a 2C score is computed by multiplying the percentile ranking for the event by the differential score to weight the event by consistency of reviews. The 2C score is entered into a database table in step 424 and is used to create the user's 2C list on the online website 36 in step 426.

In another embodiment, a 2C score is calculated by adding 1 to the differential score and dividing by 2. The result is multiplied by 100, a weighting factor of 10 is added, and that result is divided by 2 to arrive at a 2C score. In the example discussed above, in which the differential score was −0.67, this method would result in a 2C score of about 13 (exactly 13.25). In the second example described above, in which the differential score was +0.2, the 2C score by this method would be 35. The events are ranked for the user by the 2C score from highest to lowest.

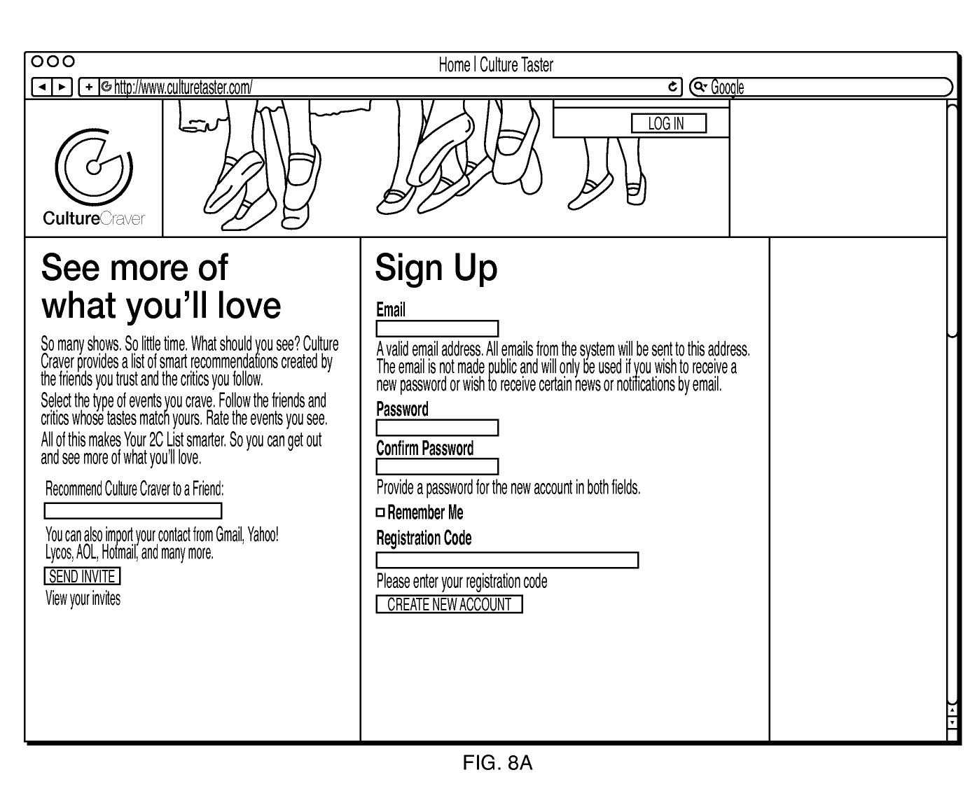

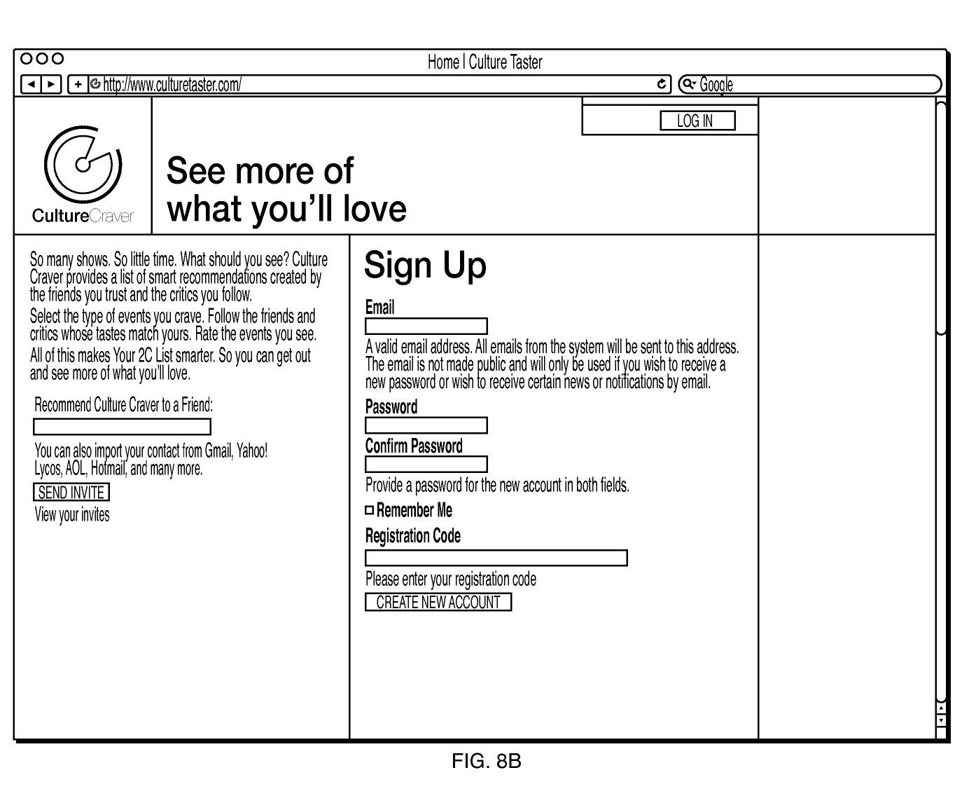

FIG. 8A is a screenshot of a user interface in the form of a sign-up page from the online website 36 generated by an embodiment of the present invention, and FIG. 8B is a screenshot of a user interface in the form of a sign-up page from the online website 36 generated by another embodiment of the present invention. The user interface allows the user 28 to access the online website 36. The screens shown in FIGS. 8A and 8B could be displayed in a conventional web browser operating on any desired computer system. As can be seen in FIGS. 8A and 8B, the user interface permits the user 28 to sign up to access the online website by entering information, such as an email address, password, registration code, etc. If the user 28 has not registered on the online website, the user 28 could click on an icon labeled “Create New Account,” which will initiate a “getting started wizard” that will prompt the user 28 to enter the demographic information described in step 102 of FIG. 4. The user 28 could recommend the online website 36 to individuals by importing their contact information from various sites, such as hotmail, or entering their contact information.

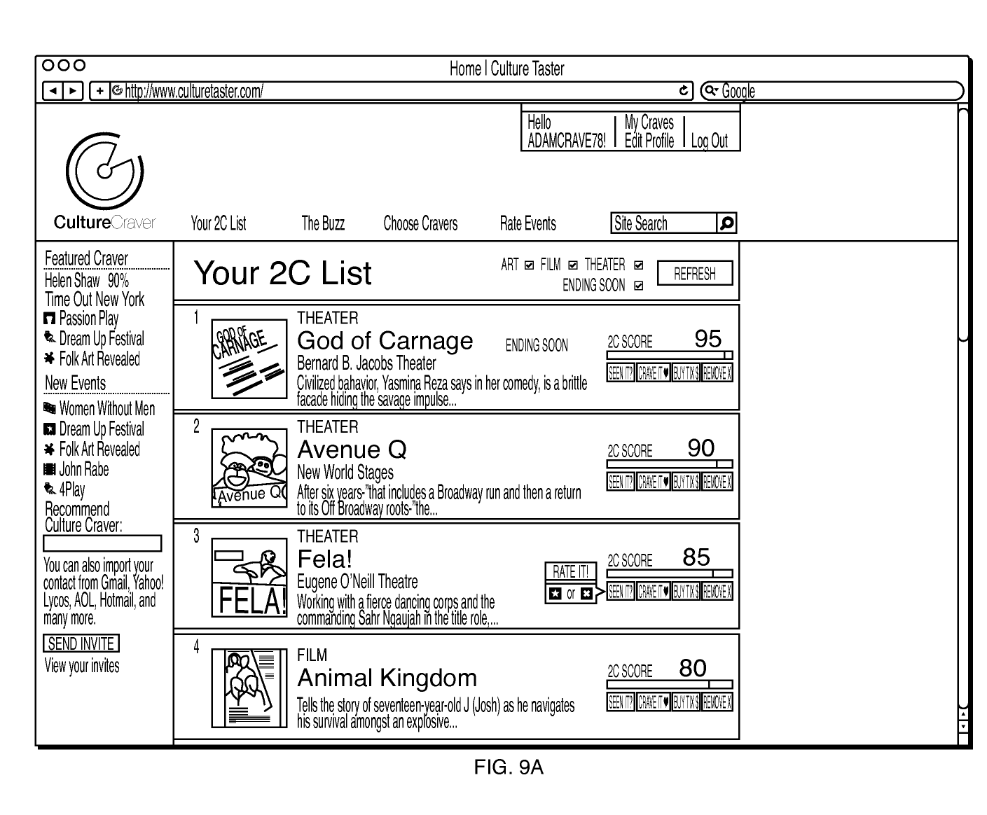

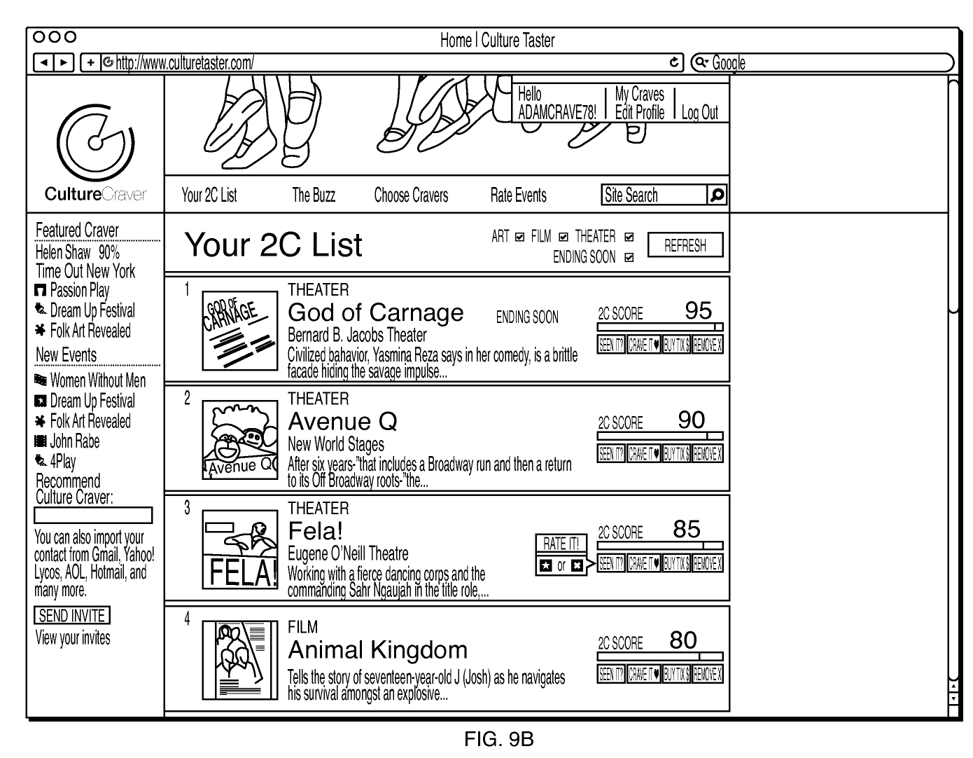

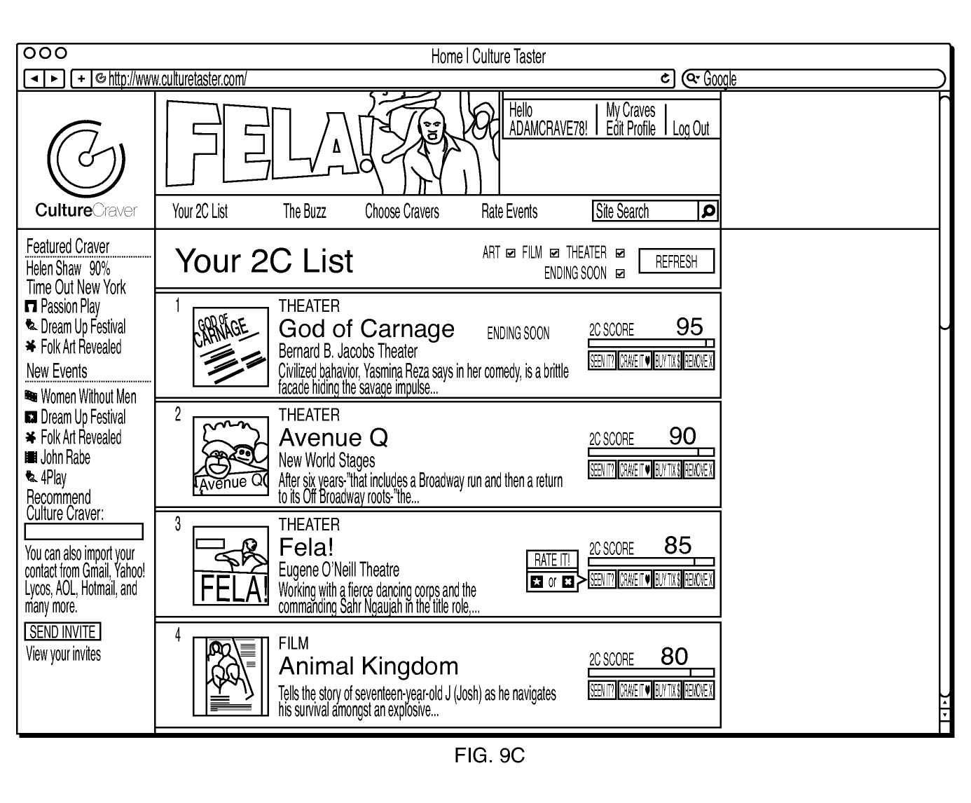

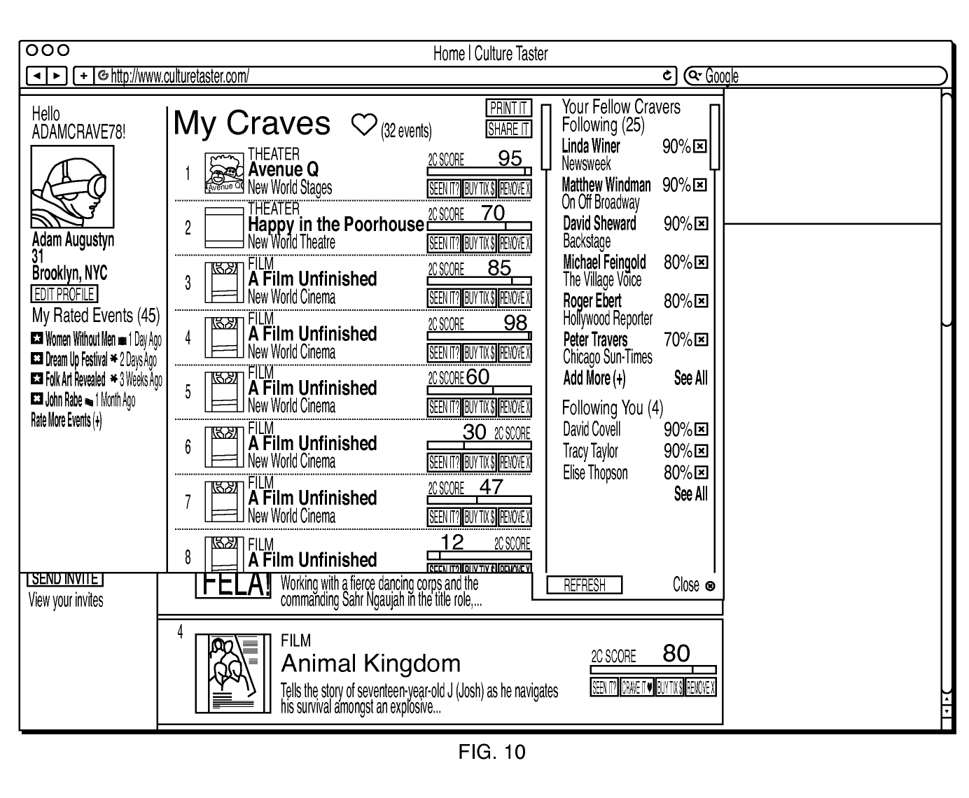

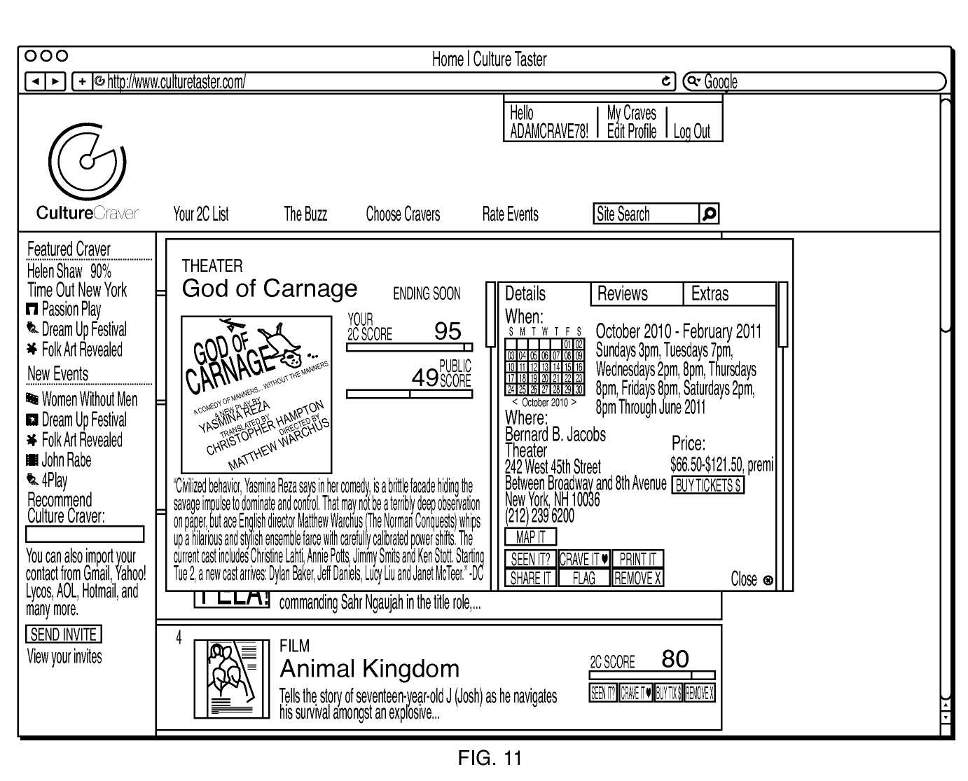

After a user 28 signs in at the online website 36, the user 28 will be able to access all features of the online, website 36 both online or using a mobile application. When the user 28 signs in, a homepage is displayed. FIGS. 9A-9C are screenshots of three sample homepages from one embodiment of the online website 36. The homepage from the online website 36 can include:
the 2C List, a personalized list for each user that displays cultural events, such as plays, movies, dance performances, and art exhibits, that come most highly recommended by individuals that the user trusts. From the 2C List, the user could click on icons to rate events, purchase tickets to the events, purchase merchandise related to the events, or remove events from the 2C List. When an user rates a cultural event, the steps of FIG. 6 are initiated, which assist to refine an user's 2C List and allows an user to share his/her recommendation about the cultural event with individuals that are being followed by the user.
A rotating list of new events, “Featured Cravers” (one person in a user's trusted network and five events that the person recently liked), and “Suggested Cravers” (individuals with whom the user has a high affinity but are not yet following). Of course, the list could include any number of events that the person recently liked.
Crave List, a personalized wish list of cultural events that the user can add to as the user comes across movies, plays, museum exhibits and dance performances that spark his or her interest. In this manner, the user could save, organize, and share events that the user is interested in attending. The Crave List could include a listing of the individuals who the user is following along with their 2C Score, and a listing of individuals who follow the user along with their 2C Score. FIG. 10 is a screenshot of a profile page from one embodiment of the online website 36 that includes a display of the Crave List.
Search Tool, which includes two key capabilities:
   Recommender Lookup, which allows users to retrieve their friends, as well as professional critics, by name to learn what they have recommended recently.
   Event Lookup, which allows users to retrieve cultural events by name to (a) learn how highly the events are rated, (b) ascertain more information about the events and the people involved from the cultural organizations that presented them, (c) buy merchandise such as posters or CDs related to the events, and (d) purchase tickets to the event.
      A user could link from the homepage to access:
Event Rater Tool, which invites users to rate popular and widely debated events. As users rate events, the steps of FIG. 6 are initiated, thereby refining the recommendation algorithm.
Culture Calendar, a calendar view that allows users to review one or more of the following layers: (a) their 2C List, (b) their Crave List, and (c) all cultural events occurring in their city, regardless of rating. The calendar listing is followed by the event's 2C Score.
Craver Chooser, which allows users to manage their trusted network.
The Buzz, which provides site-wide and personal trends, such as the most popular events on the online website, the most highly contested events, and the most popular recommenders.
Event listing page. The event's page displays (a) a listing for the event, (b) the event's 2C Score, (c) a score based generally on public opinion, (d) details of the event (the location, the price, and timing of the event), etc., and (e) other information about the event, including free advertorial content. FIG. 11 is a screenshot of an event page from one embodiment of the online website 36.

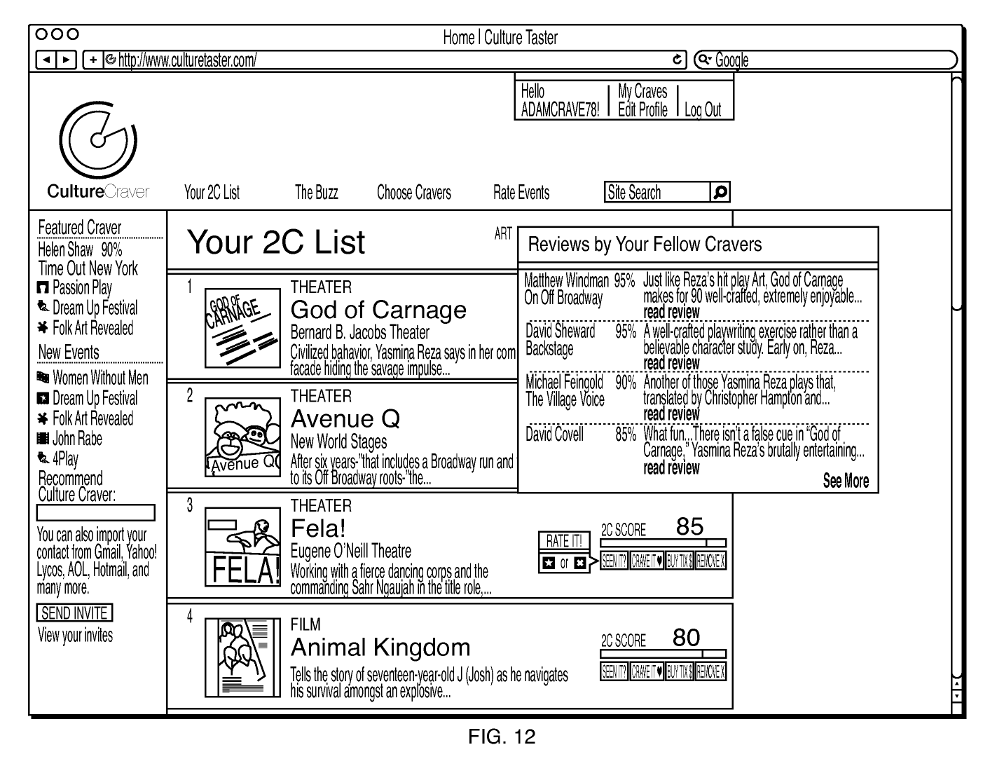

FIG. 12 is a screenshot of a review page from the online website 36, which could display the reviews made by the individuals who the user 28 is following for a particular recommended cultural event. The review page could display the affinity score of such individuals. The review page could be accessed by mouse-overs.

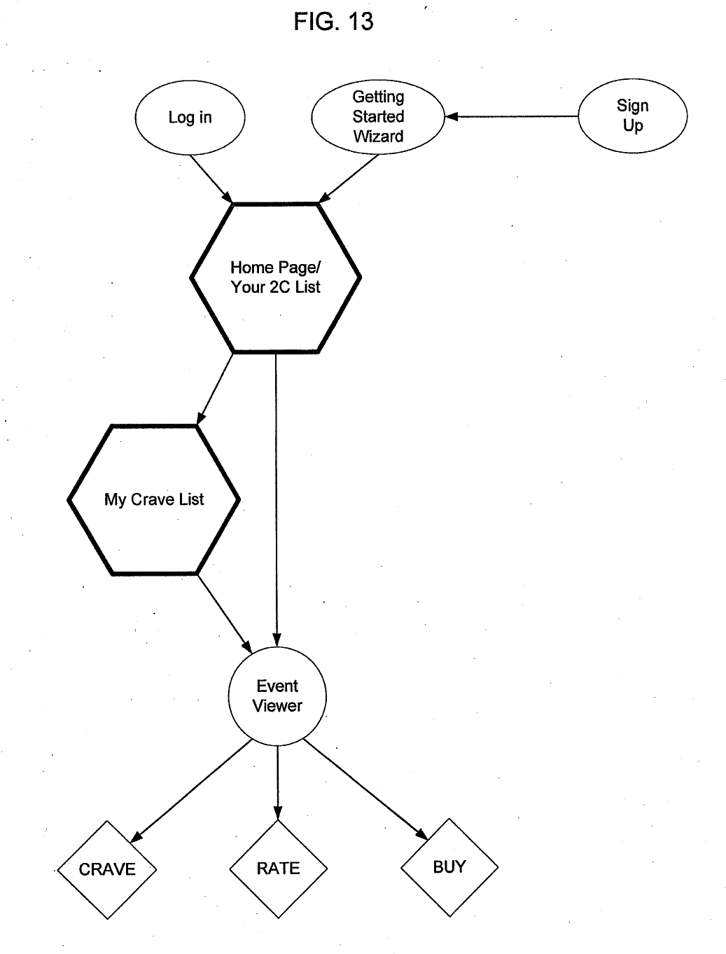

A diagram of the user's experience on the online website 36 is provided in FIG. 13. The server 12 can provide a weekly update, which includes the user's most recent 2C List, to a user's email address. The server 12 can also create a report directed to culture consumption patterns.

In another embodiment of the invention, a user can obtain richer, customized information about an event from a standard QR code using a mobile recommendation system application. Rather than scanning a QR Code using a regular QR Scanner and being directed to a standard, promotional website (for a movie, theater, or art museum, for example), a user can scan a QR code using, for example, a mobile application on a smart phone and be directed automatically to a personalized event page for the particular event. The personalized event page can provide information on how other users that they trust rate and review the event, find show times and buy tickets, and get other custom information. A QR code scanned using the mobile recommendation system application may return content that goes beyond an event page. For example, it could return an “extra” such as a video about a production.

In this embodiment of the invention, when a user finds a QR code of interest, the user can click on a “Search” tab on the user's smart phone recommendation system application, and then click on a “Scan” button. The device takes a picture of the QR Code and reads it. If the URL in the QR code is in the recommendation system database, the user is directed to a unique page (within the recommendation system application) for the event in question. There, the user will find the ratings/reviews of the event by the people they trust, as well as show times, the ability to purchase tickets, and other useful information. If the URL is not in the database, the application directs the user to the standard website (and tags the event so that it can be added to the system for future users).

From a technology perspective, the embodiment described above functions as follows. The user scans a QR code. The recommendation system database is checked to see if the QR code's URL is present. If it is present, it translates the URL into the unique page for the same event, and instructs the recommendation system application to return that page to the user. If the URL is not present, the recommendation system application sends the user to the requested URL and flags the URL to add it to the recommendation system database.

The recommendation system may also be provided with a “socializer” tool that can be used to allow two people—or a group of people—to find events they can attend, and enjoy, together. In this embodiment, a user types another user's name into the socializer tool. The recommendation system pulls up information regarding the other user, such as the user's name, his or her photo, and his or her affinity with the original user. Then the socializer tool provides the original user with a list of events (movies, plays, art exhibits) the two users have a common affinity for and can attend together. This feature can also be linked to an e-mail system, so a user can send a message to a friend with the results of the search to see if the friend would like to attend one of the suggested events together.

In another embodiment, two users may use the socializer tool with their smart phones, such as iPhones, rather than on the website. In this embodiment, the process includes a “geolocation” step. Two users open the recommendation system application and click on the “Socializer” tab. The users shake their phones simultaneously. This signals to the recommendation system that the two users want to socialize with one another. The recommendation system finds and identifies the two phones and does its calculations. The recommendation system application then tells each user his or her affinity with the other user who is shaking his or her phone. As discussed above, affinity is a measure of how much the users have historically agreed with one another. Next, the Socializer asks the two users if they want to find events to attend together. If they do, the recommendation system returns a list of events (movies, plays, art exhibits) the two users might attend together.

In this embodiment, the socializer retrieves the 2C Lists and the Crave Lists of each user. For each user, a score is assigned to each event. If an event appears on a user's Crave List, it receives a score of 100. Otherwise, the score for an event is the same as the 2C Score for the event. (Note: For example, if Harry Potter receives a 2C Score of 95, its Socializer Score is also 95. But if the user has “Craved” Harry Potter, its Socializer Score is 100.). For each event, the Socializer Scores of the people using the function are averaged. The events are then ranked in order of their Socializer Scores. The suggested events are the list that results from this process.

If the users are using the Socializer tool on mobile devices such as iPhones, before the above process takes place, the two phones undergo a pairing process. In the pairing process, the phones are shaken. This registers the phones' locations, identifies the users and places a time stamp on the recommendation system. The phone then requests a list of proximity matches from the recommendation system. The recommendation system provides information on the closest phone. This may include, for example, (a) a picture and name for the other user, (b) the user's affinity with that user and (c) the suggested events they should attend together. The recommendation system displays (a) and (b) on each user's phone. If the user clicks “Yes” to getting the list of events to attend together, his or her phone will display (c).

It will be understood that the embodiments described herein are merely exemplary and that a person skilled in the art may make many variations and modifications without departing from the spirit and scope of the invention. For example, the various algorithms described herein may be modified in numerous ways, yet still be within the scope and spirit of the invention.

I claim:

1. A method for providing recommendations for cultural events of interest to a user comprising the steps of:
(a) receiving a rating of one or more cultural events by a user indicating whether the user liked or disliked the cultural event;
(b) analyzing reviews of cultural events by one or more individual reviewers to determine whether they liked or disliked the one or more cultural events;
(c) rating the reviews by the one or more individual reviewers to indicate whether the one or more reviewers liked or disliked the cultural event;
(d) comparing the rating of the one or more cultural event by the user against the rating of the one or more cultural events by the individual reviewers to determine the degree of affinity for cultural events between the user and each of the one or more individual reviewers; and
(e) generating a list of cultural events that the user is likely to like or dislike.

2. The method of claim 1, further comprising the step of calculating a score rating the likelihood that the user will like or dislike the cultural event using an algorithm based upon the degree of affinity between the user and the individual reviewers.

3. The method of claim 1 wherein the rating of the reviews of the one or more individual reviewers provides an indication of the degree to which the reviewer liked or disliked the cultural event.

4. The method of claim 1 wherein the affinity score is determined based upon the number of times the user and the reviewer agree in liking or disliking one or more cultural events.

5. The method of claim 4, further comprising the step of generating a weighting score to identify the cultural events that the user is more probably going to like.

6. A system for generating a list of cultural events likely to be of interest to a user comprising:
a computer-readable storage medium having computer-readable instructions for instructing at least one computer system to generate a list of recommended cultural events; and
a server having an operating system for executing the computer-readable instructions, wherein the server is in communication with one or more users over a network.

7. The system of claim 6, wherein the server is in communication with one or more review editors over a network.

8. The system of claim 6 or 7 wherein the network is an Internet Protocol network.

9. A method for providing a user information about a cultural event comprising the steps of;
(a) providing a wireless device capable of scanning QR codes and having a recommendation system application;
(b) scanning the QR code and transmitting the QR code to the recommendation system;
(c) comparing the URL associated with the QR code to the URL codes in a database in the recommendation system;
(d) if the URL is present in the database, sending a unique page to the user with information on the event;
(e) if the URL is not present in the database, directing the user to the URL associated with the QR code.

10. The method of claim 9, wherein if the URL is not present in the database, the URL is added to the database.

11. A method for providing a user of a cultural event recommendation system with cultural events that are recommended for two or more users of the recommendation system comprising the steps of:
(a) inputting by a first user of the recommendation system the names of one or more other users of the recommendation system;
(b) receiving from the recommendation system information regarding the one or more user names input to the recommendation system;
(c) providing the first user with a list of cultural events for which the users each have a high affinity score.
